(19) United States
(12) Patent Application Publication
(10) Pub. No.: US 2022/0185689 A1
(43) Pub. Date: Jun. 16, 2022

(54) PROCESS FOR PREPARING ALUMINA

(71) Applicant: ALCOA OF AUSTRALIA LIMITED, Booragoon (AU)

(72) Inventors: Robert Joseph Lamacchia, Booragoon (AU); Travis Baroni, Booragoon (AU); Shannon Troy Dye, Booragoon (AU); Kevin Ronald Beckham, Booragoon (AU)

(21) Appl. No.: 17/686,756

(22) Filed: Mar. 4, 2022

Related U.S. Application Data
(63) Continuation of application No. PCT/AU2020/050939, filed on Sep. 7, 2020.

(30) Foreign Application Priority Data
Sep. 6, 2019 (AU) 2019903300

(51) Int. Cl. C01F 7/306; C01F 7/56

(52) U.S. Cl. CPC C01F 7/306; C01P 2006/80; C01F 7/56

(57) ABSTRACT

A process for preparing high purity alumina from aluminium-bearing materials originating from the Bayer process. The process comprising digesting the aluminium-bearing materials with hydrochloric acid to produce an aluminium chloride liquor and acid-insoluble solids and separating said solids from the aluminium chloride liquor, depleting the aluminium chloride liquor of one or more impurities, producing aluminium chloride hexahydrate solids from the produced aluminium chloride liquor, and thermally decomposing the produced aluminium chloride hexahydrate solids to produce high purity alumina.

### CROSS-REFERENCE TO RELATED APPLICATIONS

This application is a continuation of International Patent Application No. PCT/AU2020/050939, filed Sep. 7, 2020, which claims priority to Australian Patent Application No. 2019903300, filed Sep. 6, 2019, entitled “PROCESS FOR PREPARING ALUMINA,” each of which is incorporated herein by reference in its entirety.

### TECHNICAL FIELD

The present disclosure relates to a process for preparing alumina, in particular to a process for preparing high purity alumina from aluminium-bearing materials originating from the Bayer process.

### BACKGROUND

The following discussion of the background to the invention is intended to facilitate an understanding of the invention. However, it should be appreciated that the discussion is not an acknowledgement or admission that any of the material referred to was published, known or part of the common general knowledge as at the priority date of the application.

High purity alumina is used in a broad range of technology applications, including use as a key material in high intensity discharge lamps, LEDs, sapphire glass for precision optics, handheld devices, television screens and watch faces, synthetic gemstones for lasers, components in the space and aeronautics industry and high strength ceramic tools. It may also be used in lithium ion batteries, acting as an electrical insulator between the anode and cathode cells. A high purity specification is particularly necessary in this latter application because any significant impurities, in particular soda, would encourage undesirable electron transport between the cells.

High purity alumina may be made directly from aluminium metal by reacting a high purity aluminium metal with an acid to produce an aluminium salt solution, subsequently concentrating the solution and spray roasting the concentrated salt solution to provide aluminium oxide powder. This method is based on the premise of preparing the high purity alumina from a high purity aluminium metal feedstock to reduce potential for contamination with impurities.

Alternatively, high purity alumina may be prepared by calcining and then digesting kaolin or other clay-like materials in hydrochloric acid, whereby acid-insoluble solids are separated from the digestion mixture to produce an aluminium chloride liquor. Aluminium chloride hexahydrate (AlCl₃.6H₂O) solids may be successively crystallised in one or a series of crystallisation steps to reduce impurity levels before final calcination to produce alumina of the required purity.

Smelter or metallurgical grade alumina may be manufactured by direct calcination of aluminium hydroxide produced from bauxite by the Bayer process. However, these calcined grades of alumina may have soda content from 0.15-0.50%, which is too high for the applications discussed above.

Thus, there is a need to develop alternative and more efficient processes for preparation of high purity alumina from sources other than aluminium metal, kaolin and clay-like aluminous materials. In particular, it would be advantageous to develop a process for preparation of high purity alumina from products or by-products of the Bayer process, even those products or by-products with a soda content >0.15% and Fe, Si, Ti, Ca, Mg, K, Mo and P impurities.

### SUMMARY

The present disclosure provides a process for preparing high purity alumina.

In a first aspect there is provided a process for preparing high purity alumina from aluminium-bearing materials originating from the Bayer process comprising:
a) digesting said materials with hydrochloric acid to produce an aluminium chloride liquor and acid-insoluble solids and separating said solids from the aluminium chloride liquor;
b) depleting the aluminium chloride liquor of one or more impurities;
c) producing aluminium chloride hexahydrate solids from the aluminium chloride liquor produced in step b); and
d) thermally decomposing the aluminium chloride hexahydrate solids produced in step c) to produce high purity alumina.

High purity alumina may be prepared from various aluminium-bearing materials originating from the Bayer process, in particular products and byproducts of smelter grade alumina production. For example, the aluminium-bearing material originating from the Bayer process may be selected from a group comprising acid-soluble aluminium hydroxide compounds, acid-soluble aluminium oxyhydroxide compounds, aluminium oxide compounds, tricalcium alum inate hexahydrate, dawsonite, Al-substituted iron hydroxyl oxides, Bayer-sodalite, DSP and red mud or a mixture thereof.

In a further embodiment, the high purity alumina may be prepared from fine particulates, i.e. dust, created during the calcination of aluminium hydroxide. This calciner dust may be separated and collected from the calciner exhaust gas in any suitable way, for example the dust may be separated and collected by use of electrostatic precipitators (ESP dust), bag houses, cyclones, filters, elutriators, or any combination thereof.

The collected calciner dust for use in methods disclosed herein may have a particle size D90 of less than about 100 μm, 95 μm, 90 μm, 85 μm, 80 μm, 75 μm, 70 μm, 65 μm, 60 μm, 55 μm, 50 μm, 45 μm, 40 μm, 35 μm, 30 μm, 25 μm, or 25 μm. The calciner dust particle size D90 may be at least about 1 μm, 5 μm, 10 μm, 15 μm, 20 μm, 25 μm, 30 μm, or 35 μm. The calciner dust particle size may be in the range provided by any two of these upper and/or lower values, for example in a range of about 1-100 μm, 5-75 μm, 10-65 μm, 15-55 μm, 20-50 μm, or 25-45 μm.

Typically, such materials have a soda content of at least 0.15% which may be present as occlusions and/or as surface soda. Accordingly, in some embodiments, prior to performing step a) the process comprises removing soda from said aluminium-bearing materials.

In some embodiments, prior to performing step a) the process comprises removing surface soda from said aluminium bearing materials by scrubbing said materials with carbon dioxide. Alternatively, in other embodiments, prior to performing step a) the process comprises subjecting said materials to one or more dissolution and recrystallization of said materials from alkali solution to reduce soda and, optionally, other impurities.

In some embodiments, the resulting recrystallised material may be gibbsite. In particular, in embodiments where gibbsite is sourced from a Bayer process, the one or more recrystallizations may be performed within a Bayer process circuit.

In one embodiment, the step of digesting said materials in hydrochloric acid may be performed at a temperature of from ambient temperature to atmospheric boiling point of the resulting aluminium chloride liquor, in particular from 60° C. to 90° C., even from 75° C. to 85° C.

In some embodiments, the step of digesting said materials in hydrochloric acid may be performed for between 15 min to 6 h, in particular 3 h to 4 h.

In some embodiments, the hydrochloric acid may have a concentration of from 5 M to 12 M, in particular about 9 M.

In one embodiment, producing aluminium chloride hexahydrate solids from said liquor comprises sparging said liquor with hydrogen chloride gas.

In one embodiment, producing aluminium chloride hexahydrate solids from said liquor comprises seeding said liquor to precipitate aluminium chloride hexahydrate solids. In an example, said liquor may be seeded with aluminium chloride hexahydrate crystals in an amount of from 0.1 g/L to 50 g/L.

Said liquor may be concentrated prior to sparging with hydrogen chloride gas. In particular, said liquor may be concentrated up to 3.4 molal Al.

In one embodiment, the step of thermally decomposing the purified aluminium chloride hexahydrate solids may be performed in one or more heating stages.

For example, in one embodiment, thermally decomposing the purified aluminium chloride hexahydrate solids comprises heating the purified aluminium chloride hexahydrate solids to a temperature from about 200° C. to 1300° C., in particular from about 250° C. to about 1000° C.

In another embodiment, thermally decomposing the purified aluminium chloride hexahydrate solids comprises:
i) heating the purified aluminium chloride hexahydrate solids at a first temperature to thermally decompose said solids; and,
ii) calcining the thermally decomposed solids at a second temperature higher than the first temperature to produce high purity alumina.

In one embodiment, the first temperature may be from 200° C. to 900° C. and the second temperature may be from 1000° C. to 1300° C..

It will be appreciated by those skilled in the art that hydrogen chloride gas may be generated as a by-product of thermally decomposing the purified aluminium chloride hexahydrate solids at the first temperature and/or the second temperature. Accordingly, the process further comprises recycling the regenerated hydrogen chloride gas for sparging said aluminium chloride liquors to produce aluminium chloride hexahydrate solids.

The term ‘impurities’ as used herein refers to a metal or metalloid, other than aluminium, which may be present in said aluminium-bearing materials and is capable of co-dissolving in the aluminium chloride liquors. The one or more impurities in the aluminium chloride liquors may be selected from a group comprising Na, Fe, Si, Ti, Ca, Mg, K, Mo and P. It is generally desirable to decrease the concentrations of these impurities in said liquor prior to precipitation of aluminium chloride hexahydrate solids to avoid co-precipitation of chloride salts of the impurities, occlusion of the impurities into the aluminium chloride hexahydrate solids or adsorption on the surface of the aluminium chloride hexahydrate solids.

In some embodiments, depleting the aluminium chloride liquor of one or more impurities may comprise extracting the one or more impurities from said liquor by ion exchange, solvent extraction, or adsorption, optionally in combination with a complexing agent.

In an alternative embodiment, depleting the aluminium chloride liquor of one or more impurities may comprise selectively precipitating chloride salts of the one or more impurities. For example, said liquor may be cooled and sparged with HCl to encourage salting out of sodium chloride which can then optionally be separated from the liquor by any suitable conventional separation technique.

In a further alternative embodiment, depleting the aluminium chloride liquor of one or more impurities may comprise reacting said liquor with a complexing agent, wherein the complexing agent is capable of selectively forming a complex with one or more impurity. In this way, the complexed impurity remains in solution when aluminium chloride hexahydrate solids are produced.

In some embodiments wherein the impurity is sodium, the aluminium chloride liquor may be purified by passing it through a semi-permeable cation selective membrane, in particular a sodium selective membrane to separate sodium impurities from said liquor.

Depending on the content of impurities remaining in the aluminium chloride hexahydrate solids produced in step c), the process may further comprise: dissolving the aluminium chloride hexahydrate solids to produce a second aluminium chloride liquor and depleting said liquor of one or more impurities; and producing aluminium chloride hexahydrate solids from the second aluminium chloride liquor.

Alternatively, in embodiments where there is co-precipitation of NaCl with aluminium chloride hexahydrate solids, the process may further comprise thermally decomposing the aluminium chloride hexahydrate solids in the presence of NaCl and leaching the thermally decomposed alumina with water to remove soda.

In another aspect there is provided a process for preparing high purity alumina from calciner dust originating from the Bayer process, wherein the calciner dust is pre-treated to remove soda, the process comprising:
a) digesting said pre-treated calciner dust with hydrochloric acid to produce an aluminium chloride liquor and acid-insoluble solids and separating said solids from the aluminium chloride liquor;
b) depleting the aluminium chloride liquor of one or more impurities;
c) producing aluminium chloride hexahydrate solids from the aluminium chloride liquor produced in step b); and
d) thermally decomposing the aluminium chloride hexahydrate solids produced in step c) to produce high purity alumina.

In yet another aspect of the disclosure, there is provided a use of gibbsite and/or calciner dust such as ESP dust and/or DSP as a precursor for high purity alumina.

### BRIEF DESCRIPTION OF DRAWINGS

Preferred embodiments will now be further described and illustrated, by way of example only, with reference to the accompanying drawings in which:

FIG. 1 is a representative flow sheet of one embodiment of the process for preparing high purity alumina from gibbsite; and

FIG. 2 is a representative flow sheet of an alternative embodiment of the process for preparing high purity alumina from electrostatic precipitator dust (ESP dust).

### DESCRIPTION OF EMBODIMENTS

The present disclosure relates to a process for preparing high purity alumina.

### General Terms

Throughout this specification, unless specifically stated otherwise or the context requires otherwise, reference to a single step, composition of matter, group of steps or group of compositions of matter shall be taken to encompass one and a plurality (i.e. one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Each example of the present disclosure described herein is to be applied mutatis mutandis to each and every other example unless specifically stated otherwise. The present disclosure is not to be limited in scope by the specific examples described herein, which are intended for the purpose of exemplification only. Functionally-equivalent products, compositions and methods are clearly within the scope of the disclosure as described herein.

The term “and/or”, e.g., “X and/or Y” shall be understood to mean either “X and Y” or “X or Y” and shall be taken to provide explicit support for both meanings or for either meaning.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the present specification, including definitions, will control. In addition, the materials, methods, and examples are illustrative only and not intended to be limiting.

The term “about” as used herein means within 5%, and more preferably within 1%, of a given value or range. For example, “about 3.7%” means from 3.5 to 3.9%, preferably from 3.66 to 3.74%. When the term “about” is associated with a range of values, e.g., “about X% to Y%”, the term “about” is intended to modify both the lower (X) and upper (Y) values of the recited range. For example, “about 20% to 40%” is equivalent to “about 20% to about 40%”.

### Specific Terms

The term “alumina” as used herein refers to aluminium oxide (Al₂O₃), in particular the crystalline polymorphic phases a, y, 8 and K. High purity alumina refers to Al₂O₃ with a purity of about 99.99% suitable for use as a key material in various applications including, but not limited to, high intensity discharge lamps, LEDs, sapphire glass for precision optics, handheld devices, television screens and watch faces, synthetic gemstones for lasers, components in the space and aeronautics industry, high strength ceramic tools, or electrical insulators in lithium ion batteries.

The term ‘aluminium-bearing material originating from the Bayer process’ as used herein refers to any material with a greater than 10% content (by wt % eq. Al₂O₃) generated as a product or a byproduct of the Bayer process and alumina production. Examples of such aluminium-bearing materials include, but are not limited to, an acid-soluble aluminium hydroxide compound such as gibbsite (γ-Al(OH)₃), bayerite (α-Al(OH)₃), nordstrandite, doyleite or dawsonite (NaAl(OH)₂.CO₃), an acid-soluble aluminium oxyhydroxide compound such as diaspore (α-AlO(OH)) or boehmite (γ-AlO(OH)), tricalcium alum inate hexahydrate (TCA), or Al-substituted iron hydroxy oxide such as aluminous goethite (Fe(Al)OOH). The term also encompasses by-products of alumina production originating from the Bayer process such as calciner dust, DSP and red mud which typically have an aluminium content of >10 wt % (equiv. Al₂O₃).

The calcination of aluminium hydroxide in alumina production creates fine particulates which can be emitted as calciner dust. Calciner dust emissions may be mitigated and controlled to low levels by the use of various collection techniques such as electrostatic precipitators on the calciner stacks. ESP dust is the fine particulate residue captured by electrostatic precipitators. ESP dust particles may comprise alumina and various aluminium (oxy)hydroxide and aluminium hydroxide compounds contaminated with occluded and surface soda.

DSP is a collective term used to describe several acid-soluble silica containing compounds which precipitate within the Bayer process. DSP is mainly Bayer-sodalite having a general formula of [NaAlSiO₄]₆.mNa₂X.nH₂O, in which “mNa₂X” represents the included sodium salt intercalated within the cage structure of the zeolite and X may be carbonate (CO₃²⁻), sulfate (SO₄²⁻), chloride (Cl⁻), alum inate (AlO₄)⁻). DSP forms in the ‘desilication’ circuit of the Bayer process prior to digestion circuit and also in the digestion circuit itself. DSP ultimately becomes part of bauxite residues (e.g. red mud). Further, it will be appreciated by those skilled in the art that silica may be supersaturated in solution throughout the Bayer process, despite reducing silica content in the desilication circuit. Consequently, DSP may also form as scale on the internal surfaces of tanks, pipes and heaters.

The term ‘soda’ and ‘soda content’ as used herein refers to Na₂O and the amount of Na₂O present in a material, reported as a percentage by weight (wt %) per total weight of the material. It will be appreciated that the soda content of high purity alumina must be low. A reference to ‘surface soda’ relates to the presence of adsorbed Na₂O on the surface of a particle, while a reference to ‘occluded soda’ relates to soda encapsulated in another material.

Calcination is a thermal treatment process in which solids are heated to high temperatures (i.e. >500° C.) in in the absence of, or controlled supply of, air or oxygen, generally resulting in the decomposition of the solids to remove carbon dioxide, water of crystallization or volatiles, or to effect a phase transformation, such as the conversion of aluminium hydroxide to alumina. Such thermal treatment processes may be carried out in furnaces or reactors, such as shaft furnaces, rotary kilns, multiple hearth furnaces and fluidized bed reactors.

The term ‘atmospheric boiling point’ is used to refer to the temperature at which a liquid or slurry boils at atmospheric pressure. It will be appreciated that the boiling point may also vary according to the various solutes in the liquid or slurry and their concentration.

### Process for Preparing High Purity Alumina

High purity alumina may be prepared from various aluminium-bearing materials originating from the Bayer process.

Advantageously, the inventors have found that products or by-products of smelter grade alumina production such as gibbsite, bauxite residue, calciner dust such as ESP dust and DSP may bear significant amounts (>10% weight equivalent Al₂O₃) of aluminium (oxy)hydroxides or Bayer-sodalite which may be converted into valuable high purity alumina. Many of these materials, however, have a high impurity content, in particular soda, relative to the high purity threshold (about 99.99%) of the final desired product. Removal of the impurities to achieve the high purity threshold is technically difficult. The inventors of the processes described herein have recognised that pre-treatment of feed materials to deplete ‘surface’ impurities is desirable so that impurities are not unnecessarily introduced into the high purity alumina production process. The process as described herein subsequently depletes the remaining impurities to obtain high purity alumina.

As-received aluminium-bearing materials originating from the Bayer process may undergo a pre-treatment step to beneficiate said material. Said pre-treatment step may be any one or more beneficiation processes including, but is not limited to, concentration, gravity separation to deplete the material of gangue such as sand or quartz, or comminution to a particle size of 1 μm to 200 μm.

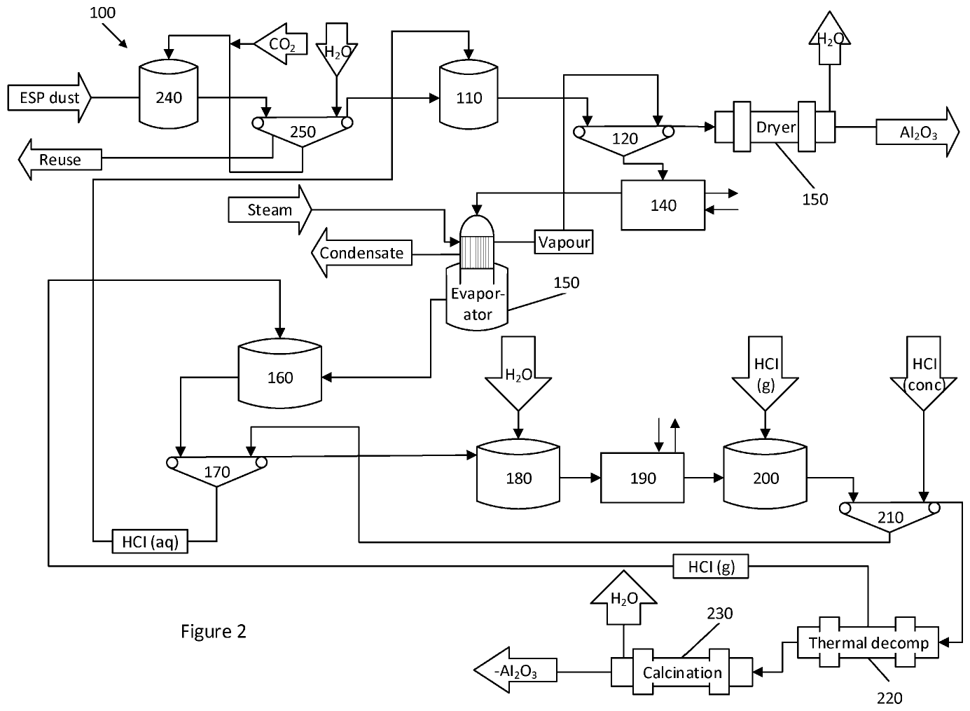

With respect to FIG. 2, it will be appreciated that the ESP dust may include occluded and surface soda. Prior to ESP dust entering the process circuit (100), surface soda may be readily removed from the ESP dust by scrubbing (240) the ESP dust with carbon dioxide to remove surface soda as sodium bicarbonate. The scrubbed ESP dust may then be subsequently filtered (250) and washed with water to remove residual sodium bicarbonate before entering the process circuit (100). It will be appreciated that the process shown in FIG. 2, and described in more detail below, is also applicable to the processing of calciner dust collected by alternate methods.

Alternatively, soluble surface soda may be at least partially removed from the ESP dust by washing with water (not shown). The washed ESP dust may then be subsequently filtered (250) before entering the process circuit (100).

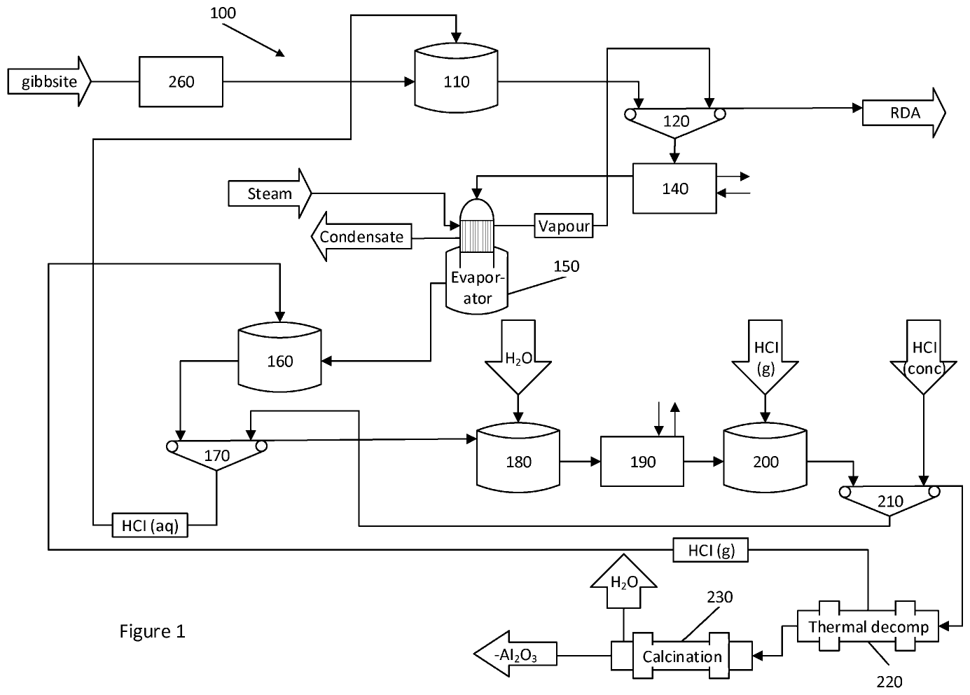

With respect to FIG. 1, gibbsite feed may be provided from a Bayer process circuit in which the gibbsite feed may have, optionally, been subjected to one or more recrystallization (260) steps from an alkali solution within the Bayer process circuit, thereby depleting said feed of one or more impurities, in particular soda.

Referring to FIGS. 1 and 2, the process (100) for preparing high purity alumina may include digesting (110) said aluminium-bearing material with hydrochloric acid to produce an aluminium chloride liquor. The hydrochloric acid may have a concentration of from 5 M to 12 M HCl, in particular 7 M to 9 M HCl.

The concentration of HCl of the resulting aluminium chloride liquor may range from 0 M to 2 M. It will be appreciated that the digestion (110) step may be performed in a batch mode or a continuous mode.. The digestion (110) step may be performed in a single reactor (vessel) or a plurality of reactors (e.g. up to 5 vessels) arranged in series such that the concentration of HCl in the liquor in each vessel in the series decreases in cascading order from about 10 M to about 2 M.

The resulting mixture may have an initial solids content of up to 50% w/w, although it will be appreciated that the solids content of the mixture will decrease as digestion progresses.

The acid digestion (110) may be performed at a temperature of from ambient temperature to atmospheric boiling point of the resulting aluminium chloride liquor, in particular from 75° C. to 85° C.

It will be appreciated that the rate of digestion will depend on the temperature, concentration of solids and acid concentration in the resulting digestion mixture. The acid digestion (110) may be performed for a period of from 15 minute to 6 hours, in particular about 3-4 hours.

After dissolution of the acid-soluble compounds is complete, the resulting aluminium chloride liquor is separated (120) from any remaining solids by any suitable conventional separation technique, such as filtration, gravity separation, centrifugation and so forth, although filtration is generally preferred. It will be appreciated that the solids may undergo one or more washings during separation.

With respect to FIG. 2, in which the aluminium-bearing material is ESP dust, the solids remaining after dissolution may include Al₂O₃. These alumina-bearing solids may be subsequently washed, dried (130) and prepared for sale.

The resulting aluminium chloride liquor may then undergo a purification process (140) to deplete said liquor of one or more impurities, in particular Na, Fe, Si, Ti, Ca, Mg, K, Mo and P. Any suitable purification process capable of reducing the concentration of any one or more of the impurities in the liquor may be employed.

For example, one of the purification processes (140) may include contacting the aluminium chloride liquor with an ion exchange resin, in particular a cation exchange resin.

Alternatively, one of the purification process (140) may include contacting the aluminium chloride liquor with an adsorbent to adsorb the one or more impurities, optionally in combination with a complexing agent. Suitable adsorbents include, but are not limited to, activated alumina, silica gel, activated carbon, molecular sieve carbon, molecular sieve zeolites and polymeric adsorbents.

One of the purification processes (140) may include selectively precipitating chloride salts of the one or more impurities. For example, said liquor may be cooled and sparged with HCl to encourage salting out of sodium chloride.

One of the purification processes (140) may include reacting said liquor with a complexing agent, wherein the complexing agent is capable of selectively forming a complex with one or more impurity. In this way, the complexed impurity may remain in solution when aluminium chloride hexahydrate solids are produced. The complexing agents may be selective for Na, Fe or Ti. Suitable complexing agents for Na include, but are not limited to, macrocyclic polyethers such as crown ethers, lariat crown ethers, and cryptands. Suitable crown ethers which demonstrate good selectivity for sodium include 15-crown 5, 12-crown 4 and 18-crown 6. Such crown ethers are soluble in aqueous solutions. Suitable complexing agents for Fe include, but are not limited to, polypyridyl ligands such as bipyridyl and terpyridyl ligands, polyazamacrocyles. Suitable complexing agents for Ti include, but are not limited to, macrocyclic ligands incorporating O, N, S, P or As donors. Other metal complexing agents may include heavy metal chelating agents such as EDTA, NTA, phosphonates, DPTA, IDS, DS, EDDS, GLDA, MGDA.

Still another purification process (140) may include solvent extraction. Suitable carriers may be non-polar solvents including, but not limited to, haloalkanes such as chloromethane, dichloromethane, chloroform, and long-chain alcohols such as 1-octanol. The crown ether complexing agents discussed above are generally more soluble in water than non-polar solvents. Accordingly, modification of the crown ether complexing agents discussed above by addition of hydrophobic groups such as benzo groups and long chain aliphatic functional groups may improve the partitioning of the crown ether complexing agent in the non-polar solvent.

In some embodiments wherein the impurity is sodium, the aluminium chloride liquor may be purified (140) by passing it through a semi-permeable cation selective membrane, in particular a sodium selective membrane to separate sodium impurities from said liquor.

After undergoing any one of the purification processes (140) described above, the resulting aluminium chloride liquor may be concentrated (150) in an evaporator to increase the Al concentration in solution.

The concentrated liquor is then passed to a crystallisation vessel where the chloride concentration in the liquor is raised (160) to saturation concentration with respect to aluminium chloride hexahydrate, thereby encouraging aluminium chloride hexahydrate to precipitate from solution. For example, the initial chloride concentration may be raised to 6 M to 12 M chloride, for example 7 M to 10 M chloride, and in particular 9 M chloride. The chloride concentration in the liquor can be readily raised by sparging with hydrogen chloride gas. In some embodiments, the chloride concentration is raised by continuous sparging with hydrogen chloride gas. Alternatively, the sparging may be periodically paused during the precipitation process. Sparging of the liquor may be paused after an initial portion of the hydrogen chloride gas has been introduced into the liquor, for example sparging may be paused after 50% of the hydrogen chloride gas has been introduced to the liquor. Advantageously, sparging with hydrogen chloride gas rather than a liquid can reduce the potential for contaminating the liquor with undesirable impurities.

The solids precipitation (160) may be performed at a temperature of from 25° C. to 100° C., in particular from 40° C. to 80° C.

The solids precipitation (160) may be performed for a period of from 1 hour to 6 hours, in particular about 3 hours. The concentrated liquor may be seeded with aluminium chloride hexahydrate crystals to assist the kinetics of crystallisation and improve the purity of the resulting product. The supernatant may be seeded with aluminium chloride hexahydrate crystals in an amount of at least 0.1 g/L, about 1 g/L, about 5 g/L, about 10 g/L, about 15 g/L, about 20 g/L, about 25 g/L, about 30 g/L, about 35 g/L, about 40 g/L, about 45 g/L, or about 50 g/L and further in a range of at least 0.1-1 g/L, 1-5 g/L, 5-10 g/L, 10-15 g/L, 15-20 g/L, 20-25 wt %, 25-30 g/L, 30-35 g/L, 35-40 g/L, 40-45 g/L, 45-50 g/L.

After solids precipitation is complete, the resulting aluminium chloride hexahydrate solids are separated (170) from the supernatant and washed with hydrochloric acid. Any suitable conventional separation technique, such as filtration, gravity separation, centrifugation, classification and so forth, may be used although filtration is generally preferred. It will be appreciated that the solids may undergo one or more washings during separation.

As the separated liquid is highly acidic, it may be conveniently recycled for use as hydrochloric acid to digest (110) the aluminium-bearing materials originating from the Bayer process.

The separated aluminium chloride hexahydrate solids may be then dissolved (180) in water and the resulting solution undergoes a purification process (190). The further purification process (190) may be any one of the purification processes as described above, and may be the same or a different process, depending on the target impurity which must be removed or the residual concentration of the remaining impurities in said solution.

The resulting purified solution is then passed to a crystallisation vessel where the chloride concentration in the liquor is raised (200) to saturation concentration with respect to aluminium chloride hexahydrate, thereby encouraging aluminium chloride hexahydrate to precipitate from solution. The chloride concentration in the liquor can be readily raised by sparging with hydrogen chloride gas. As discussed previously, sparging with hydrogen chloride gas reduces the potential for contaminating the liquor with undesirable impurities.

The solids precipitation (200) may be performed at a temperature of from 25° C. to 100° C., in particular from 40° C. to 80° C.

The solids precipitation (200) may be performed for a period of from 1 hour to 6 hours, in particular about 3 hours. The supernatant may be seeded with aluminium chloride hexahydrate crystals to assist the kinetics of crystallisation and improve the purity of the resulting product. The supernatant may be seeded with aluminium chloride hexahydrate crystals in an amount of at least 0.1 g/L, about 1 g/L, about 5 g/L, about 10 g/L, about 15 g/L, about 20 g/L, about 25 g/L, about 30 g/L, about 35 g/L, about 40 g/L, about 45 g/L, or about 50 g/L and further in a range of at least 0.1-1 g/L, 1-5 g/L, 5-10 g/L, 10-15 g/L, 15-20 g/L, 20-25 wt %, 25-30 g/L, 30-35 g/L, 35-40 g/L, 40-45 g/L, 45-50 g/L.

After solids precipitation is complete, the resulting aluminium chloride hexahydrate solids are separated (210) from the supernatant and washed with hydrochloric acid. Any suitable conventional separation technique, such as filtration, gravity separation, centrifugation, classification and so forth, may be used although filtration is generally preferred. It will be appreciated that the solids may undergo one or more washings during separation.

The separated supernatant and combined washings may be conveniently recycled for use as a washing medium for filtration (170) of aluminium chloride hexahydrate solids produced upstream.

The collected solids may then be heated (220) to a first temperature from 200° C. to 900° C. the thermally decompose said solids. Hydrogen chloride gas is evolved during thermal decomposition and may be recycled for use in the production of aluminium chloride hexahydrate solids (160), (200).

The decomposed solids are subsequently calcined (230) from 1000° C. to 1300° C. to produce high purity alumina. Any hydrogen chloride gas that may be evolved during calcination may be recycled for use in the production of aluminium chloride hexahydrate solids (160), (200).

In the embodiments shown in FIGS. 1 and 2, the aluminium chloride hexahydrate solids undergo a further purification (190) and recrystallization (200) step prior to thermal decomposition (220) and calcination (230) to high purity alumina. It will be appreciated, however, that the further purification (190) and recrystallization (200) steps which were described above may not be required in those embodiments where the remaining impurities in said solids are sufficiently low such that the alumina which would be produced from thermal decomposition and calcination of said solids collected after filtration (170) would meet the purity requirements for high purity alumina.

On the other hand, depending on the concentration of residual impurities remaining in said solids after recrystallization (200), it will also be appreciated that an additional further purification (190) and recrystallization (200) step may be required prior to thermal decomposition (220) and calcination (230) to high purity alumina.

Alternatively, in some embodiments, where there is co-precipitation of NaCl with aluminium chloride hexahydrate solids, the co-precipitated solids may be heated as described above to facilitate conversion of aluminium chloride hexahydrate to a-alumina. Sodium chloride is not expected to react with either aluminium chloride hexahydrate or alumina at these temperatures and may be readily removed by washing the alumina solids with water to dissolve any remaining NaCl.

### EXAMPLES

The following examples are is to be understood as illustrative only. The following examples should therefore not be construed as limiting the embodiments of the disclosure in any way.

### Example 1

Gibbsite (145.94 g) was slurried in deionised water and filtered. The wet solids (damp solid mass 156.1 g) were mixed with 9M HCl (600 mL) and digested at 80° C. for 20 h to produce an aluminium chloride solution. Residual solids were separated by filtration.

Hydrogen chloride gas, generated by adding 37% w/w hydrochloric acid to 98% sulphuric acid, was then bubbled through the filtered aluminium chloride solution (200 mL) using nitrogen as a carrier gas at a flow rate varying between 100 mL per 27 sec to 100 mL per 8.5 sec at 60° C. until 6.5 M HCl was obtained in the filtrate. Precipitation of aluminium chloride hexahydrate solids from the reaction mixture was initiated by seeding said mixture with analytical grade aluminium chloride hexahydrate (1 g/L).

After precipitation was complete, the resulting slurry was cooled to room temperature and then filtered to recover the aluminium chloride hexahydrate solids. Said solids were washed with 12M hydrochloric acid to remove the mother liquor.

The recovered aluminium chloride hexahydrate solids were then recrystallised by mixing said solids (144.5 g) mixed with water (104 mL) to produce a 3.4 molal aluminium chloride solution. The solution was sparged with hydrogen chloride gas (generated as described above) for about 5 h at 60° C. to precipitate aluminium chloride hexahydrate solids in a supernatant of 7.5 M HCl. The solids were filtered and washed with 12 M hydrochloric acid to remove the mother liquor.

For comparison purposes, the purity of the first and second crystallised samples of aluminium chloride hexahydrate (ACH) is shown in Table 1 below.

TABLE 1
Production of ACH from Gibbsite

| Purity | Gibbsite | First ACH | Second ACH |
|---|---|---|---|
| Al %(Al₂O₃) | 99.56 | 99.9877 | 99.99852 |
| Na (ppm) | 2383 | 29.28 | Below detectible |
| | | | limits (BDL) |
| Fe (ppm) | 75 | BDL | BDL |
| Ti (ppm) | 18 | 2.93 | BDL |
| Mg (ppm) | | 23.42 | BDL |
| K (ppm) | | 29.3 | BDL |
| Zn (ppm) | | 2.93 | BDL |
| Co (ppm) | | 2.93 | 1.0 |
| Cd (ppm) | | BDL | BDL |
| Ca (ppm) | 306 | 2.93 | BDL |

### Example 2

ESP dust was digested in fresh 9 M HCL at a temperature of 80° C. for approximately 3 hours. The composition of the resulting crystallised ACH is summarised in Table 2 below.

TABLE 2
Production of ACH from ESP dust

| Purity | First ACH |
|---|---|
| Al %(Al₂O₃) | 99.92 |
| Na (ppm) | 281.0 |
| Fe (ppm) | BDL |
| Ti (ppm) | 10.6 |
| Mg (ppm) | 12.7 |
| K (ppm) | BDL |
| Zn (ppm) | BDL |
| Co (ppm) | BDL |
| Cd (ppm) | 203.1 |
| Ca (ppm) | 9.0 |

### Example 3

An AlCl₃ solution was prepared by digesting ESP dust in 9M HCl. To prepare the solution, the ESP dust was charged into the HCl solution at approximately 50g ESP dust per 100 mL HCl in order to target close to zero acid concentration at the end of the digest.

From the AlCl₃ solution, a low impurity level liquor was produced by mixing with equal parts water, a high impurity level liquor was produced by spiking with inorganic impurities, and middle impurity level liquors produced by blending mixtures of the low and high impurity level liquors.

The precipitation of aluminium chloride hexahydrate solids was conducted by placing 180 mL of the starting liquor in a jacketed round bottom flask controlled to the desired temperature. Precipitation was initiated by seeding the starting liquor with aluminium chloride hexahydrate at 5, 22.5 or 40 g/L.

Sparging of the liquor was conducted by placing a volume of HCl in an acid dropper that would drip HCl solution into a magnetically stirred solution of concentrated H₂SO₄. The liberated HCl gas was bubbled through the solution in the round bottom flask. In some cases, sparging was paused for 15 or 30 minutes after providing 50% of the initial volume of HCl before recommencing sparging.

A summary of the experimental data with varying precipitation conditions for low, medium and high impurity level solutions is provided in Table 3 below.

TABLE 3
Varying Precipitation Conditions in
the Production of ACH from ESP dust

| | Precipitation conditions | | | | |
|---|---|---|---|---|---|
| Starting | | Seed | | Final Acid | First |
| Liquor | Temper- | Concen- | Acid | Concen- | ACH |
| Impurity | ature | tration | Pause | tration | Al |
| Level | (° C.) | (g/L) | (min) | (M) | %(Al₂O₃) |
| Low | 40 | 40 | 0 | 10.09 | 99.99 |
| Low | 40 | 40 | 0 | 8.45 | 99.96 |
| Low | 60 | 40 | 30 | 7.18 | 99.99 |
| Low | 60 | 40 | 30 | 8.51 | 99.99 |
| Low | 40 | 5 | 30 | 9.75 | 99.99 |
| Low | 40 | 5 | 30 | 7.80 | 99.99 |
| Low | 60 | 5 | 0 | 8.64 | 100.00 |
| Medium | 50 | 22.5 | 15 | 4.31 | 99.98 |
| Medium | 50 | 22.5 | 15 | 8.94 | 99.99 |
| Medium | 50 | 22.5 | 15 | 9.31 | 99.98 |
| Medium | 50 | 22.5 | 15 | 9.28 | 99.99 |
| High | 40 | 5 | 0 | 10.05 | 99.65 |
| High | 40 | 5 | 0 | 10.55 | 99.73 |
| High | 40 | 5 | 0 | 7.54 | 99.94 |
| High | 60 | 5 | 30 | 8.28 | 99.96 |
| High | 60 | 5 | 30 | 7.91 | 99.97 |
| High | 60 | 40 | 0 | 7.86 | 99.97 |
| High | 40 | 40 | 30 | 10.33 | 99.73 |
| High | 40 | 40 | 30 | 8.34 | 99.93 |

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

We claim:

1. A process for preparing high purity alumina from aluminium-bearing materials originating from the Bayer process comprising:
a) digesting said aluminium-bearing materials with hydrochloric acid to produce an aluminium chloride liquor and acid-insoluble solids and separating said solids from the aluminium chloride liquor;
b) depleting the aluminium chloride liquor of one or more impurities;
c) producing aluminium chloride hexahydrate solids from the aluminium chloride liquor produced in step b); and
d) thermally decomposing the aluminium chloride hexahydrate solids produced in step c) to produce high purity alumina.

2. The process according to claim 1, comprising, prior to step a), removing surface soda from said aluminium-bearing materials by scrubbing said materials with carbon dioxide.

3. The process according to claim 1, comprising, prior to step a), subjecting said aluminium-bearing materials to one or more dissolution and recrystallizations of said materials from alkali solution to reduce soda and, optionally, other impurities.

4. The process according to claim 3, wherein the recrystallised material is gibbsite.

5. The process according to claim 4, wherein the gibbsite is sourced from a Bayer process, and wherein the one or more dissolution and recrystallizations are performed within a Bayer process circuit.

6. The process according to claim 1, wherein the producing aluminium chloride hexahydrate solids from said liquor comprises sparging said liquor with hydrogen chloride gas.

7. The process according to claim 1, wherein the producing aluminium chloride hexahydrate solids from said liquor comprises seeding said liquor to precipitate aluminium chloride hexahydrate solids.

8. The process according to claim 7, wherein said liquor is seeded with aluminium chloride hexahydrate crystals in an amount of from 0.1 g/L to 50 g/L.

9. The process according to claim 1, wherein the thermally decomposing the purified aluminium chloride hexahydrate solids comprises:
i) heating the purified aluminium chloride hexahydrate solids at a first temperature to thermally decompose said solids; and,
ii) calcining the thermally decomposed solids at a second temperature higher than the first temperature to produce high purity alumina.

10. The process according to claim 9, wherein the first temperature is from 200° C. to 900° C. and the second temperature is from 1000° C. to 1300° C.

11. The process according to claim 9, wherein hydrogen chloride gas is generated as a by-product of the thermally decomposing the purified aluminium chloride hexahydrate solids at the first temperature and/or the second temperature.

12. The process according to claim 11, comprising recycling the regenerated hydrogen chloride gas for sparging said aluminium chloride liquors to produce aluminium chloride hexahydrate solids.

13. The process according to claim 1, wherein the depleting the aluminium chloride liquor of one or more impurities comprises at least one of:
extracting the one or more impurities from said liquor by ion exchange, solvent extraction, or adsorption, optionally in combination with a complexing agent; and
selectively precipitating chloride salts of the one or more impurities.

14. The process according to claim 1, wherein the depleting the aluminium chloride liquor of one or more impurities comprises reacting said liquor with a complexing agent, the complexing agent being capable of selectively forming a complex with one or more impurity and the complexed impurity remains in solution when aluminium chloride hexahydrate solids are produced.

15. The process according to claim 14, wherein the complexing agent comprises a macrocyclic polyether selective for sodium.

16. The process according to claim 1, wherein the depleting the aluminium chloride liquor of one or more impurities comprises passing said liquor through a semi-permeable cation selective membrane, wherein the membrane is selective to sodium.

17. The process according to claim 1, comprising:
dissolving the aluminium chloride hexahydrate solids in water to produce a second aluminium chloride liquor and depleting said liquor of one or more impurities; and
producing aluminium chloride hexahydrate solids from the second aluminium chloride liquor.

18. The process according to claim 1, comprising leaching the thermally decomposed alumina produced in step d) with water to remove soda.

19. The process according to claim 1, wherein the aluminium-bearing material originating from the Bayer process is selected from a group comprising acid-soluble aluminium hydroxide compounds, acid-soluble aluminium oxyhydroxide compounds, tricalcium aluminate hexahydrate, dawsonite, Al-substituted iron hydroxy oxides, Bayer-sodalite, calciner dust, DSP and red mud or a mixture thereof.
